(19) United States
(12) Patent Application Publication
(10) Pub. No.: US 2025/0260171 A1
(43) Pub. Date: Aug. 14, 2025

(54) Method and device for controlling a set of reconfigurable intelligent surfaces

(71) Applicant: ORANGE, ISSY-LES-MOULINEAUX (FR)

(72) Inventors: Youssef HUSSEIN, CHATILLON CEDEX (FR); Thierry CLESSIENNE, CHATILLON CEDEX (FR)

(21) Appl. No.: 19/045,037

(22) Filed: Feb. 4, 2025

(30) Foreign Application Priority Data
Feb. 8, 2024 (FR) 2401238

(51) Int. Cl. H01Q 15/00; H04W 88/08

(52) U.S. Cl. CPC H01Q 15/002; H01Q 15/0086; H04W 88/08

(57) ABSTRACT

A method for controlling a set of reconfigurable intelligent surfaces. The method includes: selecting, from among the set, at least one surface as an “intermediate surface”, and at least one surface as a “main surface”, the selection being made so as to optimize a determined communication performance criterion for antennas situated in the geographical area served by each main surface; determining phase shifts of reflective elements of the at least one selected intermediate surface and at least one selected main surface; and controlling reflective elements of the at least one intermediate surface and at least one main surface, both selected by using the determined phase shifts.

### CROSS REFERENCE TO RELATED APPLICATIONS

The present application claims priority to French Patent Application No FR2401238, filed on Feb. 8, 2024, the content of which is incorporated herein by reference in its entirety.

### TECHNICAL FIELD

The disclosed technology belongs to the field of wireless communications systems. It more specifically relates to a method for controlling a set of reconfigurable intelligent surfaces associated with a cell of a communication network served by a base station, as well as a control device configured to implement such a control method.

### DISCUSSION OF RELATED TECHNOLOGY

As is known, a reconfigurable reflective surface, hereinafter referred to as a “RIS” (Reconfigurable Intelligent Surface) for the sake of brevity, is a surface including a plurality of elements, the respective reflective properties of which can be modified. For more details concerning the operation of an RIS, one may for example consult the following document “Smart Radio Environments Empowered by Reconfigurable Intelligent Surfaces: How it Works, State of Research, and Road Ahead”, M. D. Renzo, A. Zappone, M. Debbah, M. Alouini, C. Yuen, J. D. Rosny, and S. Tretyakov, IEEE Journal on Selected 5 Areas in Communications, pages 2450-2524, 2020.

In practice, such an RIS is intended to reflect incident radio signals in a passive manner, i.e. without amplification of said incident radio signals by amplifiers (or by low-noise amplifiers or by power amplifiers). By modifying the reflective properties of each element of the RIS, for example by individually modifying the phase shift introduced by each of these reflective elements, it is possible to influence the way in which the incident radio signals are reflected by the RIS and, ultimately, to influence the propagation channel taken by these radio signals.

For this reason, an RIS constitutes an effective means for allowing exchanges of data between a base station and geographical areas which would otherwise be poorly served (or not served at all.) This aspect is for example illustrated with FIG. 1 which schematically represents an example of a wireless communications system using an RIS 12.

As illustrated by FIG. 1, the wireless communication system includes a base station 11 installed at the highest point of a tower block, which must exchange data (over a downlink and/or an uplink) with user terminals situated in a geographical area ZG to be served. In this example, the direct paths between the base station 11 and the geographical area ZG to be served are obstructed by buildings, so that the radio signals taking these direct paths are heavily attenuated, or even blocked.

By placing the RIS 12 on an adjacent tower block, it is possible to improve the reflection of the incident radio signals by this adjacent tower block, and to thus promote an indirect path between the geographical area ZG and the base station 11, by way of the RIS 12. For this purpose, a control device (not shown on FIG. 1, and for example incorporated into the base station 11), determines the appropriate phase shifts of the reflective elements of the RIS 12 to allow this latter to serve the geographical region ZG. Once determined, these phase shifts are transmitted to the RIS 12 via a backhaul network. A command module of the RIS 12 is then used to control the reflective elements so that these latters introduce phase shifts matching those determined by the control device.

The advantages related to the use of an RIS are not limited to the possibility of serving areas which would otherwise remain poorly served (or not served at all). Specifically, the energy consumption of an RIS is negligible with respect to that of a base station. Furthermore, an RIS is simpler to install from a technical and regulatory point of view. All these aspects justify the high degree of interest in this technology and the desire of operators to boost its development, particularly in the context of the deployment of wireless communication systems of 5G-Advanced or 6G type, particularly suited to the context of spatial multiplexing of different user terminals (multi-user multiple input multiple output or MU-MIMO).

The fact remains that the use of the single RIS 12 to create an indirect path between the base station 11 and the geographical area ZG may not be enough to allow a plurality of terminals to be served with sufficient quality of service.

Specifically, when the base station 11 includes an array of antennas including a plurality of antennas, the maximum number of user terminals which can be spatially multiplexed, when the propagation channels are sufficiently decorrelated with one another, corresponds to the minimum out of the number of antennas of the antenna array of the base station 11 and the number of elements of the RIS 12.

In practice, the number of user terminals that can actually be spatially multiplexed depends on the rank of the matrix of the propagation channel between the different user terminals and the different antennas of the antenna array of the base station 11. However, in the case of the wireless communication system of FIG. 1 in which an RIS 12 is used to extend the coverage of a service in situations of very degraded propagation, this rank cannot be greater than the rank of the matrix of the propagation channel between the different antennas of the antenna array of the base station 11 and the different elements of the RIS 12. However, this matrix of the propagation channel between the base station 11 and the RIS 12 can in practice have a fairly low rank, in particular in the case of frequencies greater than 30 Gigahertz (GHz) (for example for millimeter waves), or even greater than 1 Terahertz (THz), and/or in the situation where the RIS 12 is located in a situation of direct line of sight (LOS) with the base station 11. Thus, in such a case, the propagation channel between the base station 11 and the RIS 12 acts as a bottleneck which can greatly limit the achievable performance in terms of spatial multiplexing gains.

To remedy these drawbacks, provision has been made for positioning a plurality of RISs between a base station and a geographical area to be served. More specifically, said plurality of RISs includes a so-called “main” RIS and a plurality of so-called “intermediate” RISs:
the main RIS being arranged between the intermediate RISs and the geographical area to be served,
the intermediate RISs being arranged between the base station and the main RIS.

The term “main RIS arranged between the intermediate RISs and the geographical area to be served” should be understood to mean that, in the downlink direction (or in the uplink direction respectively), radio signals coming from each intermediate RIS (or coming from the geographical area respectively) reach the geographical area (or each intermediate RIS respectively) via said main RIS, after reflection thereby. Similarly, the term “intermediate RIS arranged between the base station and the main RIS” should be understood to mean that, in the downlink direction (or in the uplink direction respectively) radio signals coming from the base station (or coming from the main RIS respectively) reach the main RIS (or the base station respectively) via an intermediate RIS, after reflection thereby.

These considerations result, in particular, in a main RIS being arranged closer to the geographical area to be served than the intermediate RISs.

Such a configuration in which a plurality of RISs is used is for example illustrated with FIG. 2.

In FIG. 2, and according to similar considerations to those described above for FIG. 1, the wireless communication system includes a base station 21 which must exchange data with user terminals situated in a geographical area ZG to be served. The wireless communication system further includes a plurality of RISs, namely a main RIS 20_4 and three intermediate RISs 20_1, 20_2, 20_3.

As illustrated by FIG. 2, at least some of the radio signals coming from the base station 21 may reach the geographical area ZG by being reflected, first by the intermediate RISs 20_1, 20_2, 20_3, then by the main RIS 20_4, and conversely, according to the uplink or downlink direction in question.

The introduction of the intermediate RISs 20_1, 20_2, 20_3 makes it possible to increase the rank of the matrix of the propagation channel between the base station 21 and the main RIS 20_4, by increasing the number of indirect paths usable between said base station 21 and said main RIS 20_4, each intermediate RIS 20_1, 20_2, 20_3 making it possible to introduce a distinct indirect path between said base station 21 and said main RIS 20_4.

The communication cell served by the base station 21 does however cover an area which extends beyond the single geographic area ZG. Consequently, user terminals situated in the cell served by the base station 21, but nonetheless outside the geographic area ZG, are not able to benefit from the advantage related to the increase in the rank of the matrix of the propagation channel between the base station 21 and the main RIS 20_4.

### SUMMARY

The disclosed technology has the aim of remedying all or part of the drawbacks of the prior art, particularly those set out above, by making provision for a solution which makes it possible, based on a given set of RISs, to improve the transmission of data between an access point (e.g. a base station) and at least one user terminal situated in a geographical area covered by the access point.

For this purpose, and according to a first aspect, the disclosed technology relates to a method for controlling a set E of reconfigurable intelligent surfaces associated with an access point. Said method includes steps of:
selecting, from among the set E, at least one surface as “intermediate surface” and at least one surface as “main surface”, each surface of the set E being associated with a given geographical area covered by the access point and which it is intended to serve if it is selected as main surface, each intermediate surface being positioned between the access point and a main surface and also intended to reflect toward said main surface signals emitted by the access point to exchange data with at least one user terminal situated in the geographical area served by said main surface, the selection being made so as to optimize a determined communication performance criterion for at least one user terminal in the geographical area served by each main surface,
determining phase shifts of reflective elements of said at least one selected intermediate surface and at least one selected main surface,
controlling reflective elements of said at least one intermediate surface and at least one main surface, both selected by means of the determined phase shifts.

This first aspect of the disclosed technology falls within the context of a communication downlink between the access point and said at least one user terminal with which data are exchanged. It is however important to note that these provisions are not limiting of the disclosed technology, this latter also being able to be implemented, according to similar technical provisions, in the context of a communication uplink between said at least one user terminal and the access point.

Thus, and according to another aspect, the disclosed technology relates to a method for controlling a set E of reconfigurable intelligent surfaces associated with an access point. Said method includes steps of:
selecting, from among the set E, at least one surface as “intermediate surface” and at least one surface as “main surface”, each surface of the set E being associated with a given geographical area covered by the access point and from which it is intended to receive signals emitted by at least one user terminal to exchange data with the access point if it is selected as a main surface, each intermediate surface being positioned between the access point and a main surface from which the intermediate surface is intended to receive signals to reflect them toward the access point, the selection being made so as to optimize a determined communication performance criterion for at least one user terminal situated in the geographical area served by each main surface,
determining phase shifts of reflective elements of said at least one selected intermediate surface and at least one selected main surface,
controlling the reflective elements of said at least one intermediate surface and at least one main surface, both selected by means of the determined phase shifts.

The control method according to the disclosed technology thus makes it possible to assign, for each of the reconfigurable intelligent surfaces of the set E, a role to play as intermediate surface or main surface, it being understood that the determination of a role of intermediate surface for a given surface of the set E defines an association of this surface with a main surface toward which it is intended to reflect signals initially emitted by the base station in the context of a communication downlink (or from which it is intended to receive signals initially emitted by at least one user terminal in the context of a communication uplink, respectively).

In the remainder of the text, the control method according to the disclosed technology makes provision for each of the reconfigurable intelligent surfaces of the set E to then be effectively configured to play the role that has been assigned to it.

Thus, and unlike the prior art, the advantages related to the deployment of a plurality of reconfigurable intelligent surfaces (i.e. improvement of rank) can be put in the service of different geographical areas of the communication cell served by the base station.

Specifically, the fact of being able to determine the roles respectively played by the reconfigurable intelligent surfaces makes it possible to dispense with the limitations resulting from a fixed situation and imposed in terms of roles played, and therefore ultimately to be able to vary the different geographical areas with which data are exchanged.

In this way, it is for example possible to take into account the distribution of user terminals in these areas as well as their dynamic while guaranteeing excellent communication performance.

In particular embodiments, the control method (in the context of a communication downlink and/or a communication uplink) can moreover include one or more of the following features, taken in isolation or in any technically possible combination.

In particular embodiments, the steps of selecting, determining the phase shifts and controlling form a set of steps, said set of steps being iterated.

The fact of iterating these steps offers the possibility of updating over time the selection of the reconfigurable intelligent surfaces of the set E, i.e. of modifying the distribution of the roles that have been assigned to them. In other words, the advantage resulting from the possibility of selecting the surfaces as intermediate or main surfaces to adapt to a communication scenario at a given time (areas to be served, presences of terminals in these areas, quality of service to be achieved for the terminals served, etc.) is here extended in time to take into account a possible change of this context.

In particular embodiments, said set of steps is iterated according to a determined time increment corresponding to the coherence time associated with the signals emitted by the access point or by said at least one user terminal, or with a determined slot of the coherence time.

Choosing a time increment corresponding to the coherence time or else to a slot thereof falls in the category of, for example, considerations relating to a trade-off between optimality of the communication performance criterion and computational load. More specifically, if the time increment is chosen to be equal to one slot of the coherence time, the optimality of the communication performance criterion is privileged over the reduction in computational load and vice versa if the time increment is chosen to be equal to the coherence time).

In particular embodiments, the communication performance criterion is representative of at least one element from among:
a bitrate of the data which can be exchanged between the access point and at least one user terminal situated in the geographical area served by each main surface,
a level of quality of service of the exchanges of data between the access point and at least one user terminal situated in the geographical area served by each main surface,
an energy required to carry out exchanges of data between the access point and at least one user terminal situated in the geographical area served by each main surface,
a signal-to-noise ratio of the exchanges of data between the access point and at least one user terminal situated in the geographical area served by each main surface.

In particular embodiments, in which the communication link under consideration is a downlink, the optimization of the performance criterion takes into account, as optimization variable and for at least one user terminal situated in the geographical area served by a main surface, a parameter representative of the fact that said at least one user terminal is served or not.

These provisions are advantageous in that they make it possible to take more account of the fact that the user terminals can have a dynamic of their own within a communication cell served by the access point. The “dynamic” of the user terminals refers to the fact that these latters may be mobile within a geographical area, and can thus leave it or enter it over time. In other words, the list of user terminals served is not fixed and can be adapted to the time of solving of the optimization problem.

In particular embodiments, in which the communication link under consideration is a downlink, the control method includes, prior to the selecting step, a step of determining, for each surface of the set E, the user terminals to be served by said surface if it is selected as main surface.

These provisions are advantageous in that they make it possible to fix the list of user terminals to be served at the time of optimization of the communication performance criterion, so as to limit the number of optimization parameters of this criterion and thus reduce the computational load.

In particular embodiments, said time increment corresponds to the coherence time, said coherence time is sampled into a plurality of determined slots, the optimization of the performance criterion taking into account, as optimization variable and for each surface of the set E, a parameter representative of the number of slots of the coherence time during which said surface is selected as main surface.

These provisions make it possible to obtain an effective trade-off in terms of optimality/computational load ratio. Specifically, the frequency at which the optimization problem is solved (coherence time) does indeed limit the taking into account of the dynamic of the user terminals, but nonetheless makes it possible to reduce the computational load. Whatever the circumstances, this optimization problem also makes it possible to take into account the proportion of time (over the total duration of the coherence time) during which a surface plays the role of main RIS, which advantageously contributes to improving said optimality/computational load ratio.

In particular embodiments, in which the communication link under consideration is a downlink, the optimization of the performance criterion is parameterized such that:
the selection of a plurality of main surfaces is allowed, and
the intermediate surface or surfaces selected to reflect signals toward one main surface are distinct from the intermediate surface or surfaces selected to reflect signals toward another main surface.

These provisions are advantageous in that they make it possible to divide up the surfaces of the set E into a plurality of groups of surfaces, each group including one main surface and at least one intermediate surface. Thus, at one and the same time, several main surfaces can be active, and therefore several geographical areas can be served. In addition, each area is served by such a group of surfaces for which the rank of the matrix of the propagation channel between the access point and the main surface of said group is increased.

In particular embodiments, in which the communication link under consideration is a downlink, the step of determining the phase shifts is implemented such that the power of the signals reflected by an intermediate surface toward a main surface is greater than a given threshold or maximized, said power being a function parameterized by said phase shifts, angles of the signals emitted by the base station toward said intermediate surfaces as well as angles of departure of the signals reflected by said intermediate surface toward said main surface.

In particular embodiments, in which the communication link under consideration is an uplink, the step of determining the phase shifts is implemented such that the power of the signals reflected by an intermediate surface toward the access point is greater than a given threshold or maximized, said power being a function parameterized by said phase shifts, angles of the signals reflected by said at least one main surface toward said intermediate surface as well as angles of the signals reflected by said intermediate surface toward the access point.

The fact of determining the phase shifts of an intermediate surface in this way makes it possible to take into account the precise physical reality in which said intermediate surface is located.

This physical reality refers to:
in the context of a communication downlink, the angles of the signals reaching the intermediate surface from the access point (these angles are thus angles of “incidence” from the access point toward the intermediate surface) as well as the angles of signals reaching said at least one main surface from the intermediate surface (these angles are thus angles of “departure” from the intermediate surface toward said at least one main surface),
in the context of a communication uplink, the angles of the signals reaching the intermediate surface from said at least one main surface (these angles are thus angles of “incidence” from said at least one main surface toward the intermediate surface) and the angles of signals reaching the access point from the intermediate surface (these angles are thus angles of “departure” from the intermediate surface toward the access point).

Proceeding in this way makes it possible to configure the intermediate surface advantageously so that the reflection of signals toward said at least one main surface in the context of a communication downlink (or toward the access point in the context of a communication uplink respectively) is done in a much more directed and concentrated manner than in the prior art. In this way, the main surface may serve the antennas of user equipment items situated in the geographical area very effectively in the context of a communication downlink (or the data emitted by user equipment items situated in the geographical area arrive at the access point very effectively in the context of a communication uplink, respectively).

In particular embodiments, the phase shifts are also determined such that the power of signals reflected by an intermediate surface toward at least one other intermediate surface is less than a given threshold or minimized.

It will specifically be understood that if each intermediate surface is configured to reflect signals coming from the access point toward a main surface in the context of a communication downlink, or coming from a main surface toward the access point in the context of a communication uplink, there may be a risk of some of these reflections being uncontrolled so that they are ultimately directed elsewhere, thus in particular toward another intermediate surface. The present provisions are therefore advantageous in that they make it possible to reduce interference vis-à-vis other intermediate surfaces.

In particular embodiments, in which the communication link under consideration is a downlink, the phase shifts are also determined such that the power of signals reflected by an intermediate surface directly toward at least one user terminal situated in the geographical area served by the main surface toward which signals are reflected by said intermediate surface is less than a given threshold or minimized.

According to similar considerations to those mentioned above, the present provisions are advantageous in that they make it possible to reduce interference resulting from uncontrolled reflections directed directly toward antennas.

According to another aspect, the disclosed technology relates to a computer

program including instructions for implementing a control method according to the disclosed technology when said program is executed by a computer.

This program can use any programming language, and be in the form of source code, object code, or intermediate code between source code and object code, such as in a partially compiled form, or in any other desirable form.

According to another aspect, the disclosed technology relates to an information or recording medium readable by a computer on which is recorded a computer program according to the disclosed technology.

The information or recording medium can be any entity or device capable of storing the program. For example the support may include a storage means, such as a ROM, for example a CD-ROM or a microelectronic circuit ROM, or else a magnetic recording means, for example a hard disk.

Moreover, the information or recording medium can be a transmissible medium such as an electrical or optical signal, which can be conveyed via an electrical or optical cable, by radio or by other means. The program according to the disclosed technology can in particular be downloaded over a network of Internet type.

Alternatively, the information or recording medium can be an integrated circuit into which the program is incorporated, the circuit being suitable for executing or for being used in the execution of the method in question.

According to another aspect, the disclosed technology relates to a control device including means configured to implement a control method according to the disclosed technology.

According to another aspect, the disclosed technology relates to a wireless communication system including an access point, a set E of reconfigurable intelligent surfaces associated with the access point, and also a control device according to the disclosed technology.

### BRIEF DESCRIPTION OF THE DRAWINGS

Other features and advantages of the disclosed technology will become apparent from the description given below, with reference to the appended drawings which illustrate an exemplary embodiment devoid of any limitation. On the figures:

FIG. 1, already described, schematically represents an example of a wireless communication system of the prior art, in which a single RIS is used to serve a given geographical area;

FIG. 2, already described, schematically represents an example of a wireless communication system of the prior art, in which a plurality of intermediate RISs and a main RIS are used to serve a given geographical area;

FIG. 3 schematically represents a wireless communication system according to a particular embodiment of the disclosed technology;

FIG. 4 is an alternative schematic representation of FIG. 3, in which RISs belonging to the wireless communication system are respectively associated with geographical areas to be served;

FIG. 5 schematically represents an example of a hardware architecture of a control device belonging to the wireless communication system of FIGS. 3 and 4;

FIG. 6 represents, in the form of a block diagram, a particular embodiment of the control method executed by the device of FIG. 5.

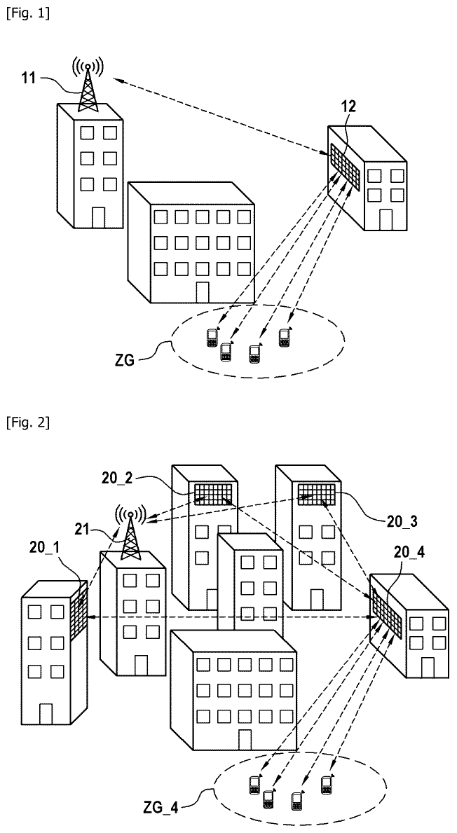

### DESCRIPTION OF ILLUSTRATIVE EMBODIMENTS

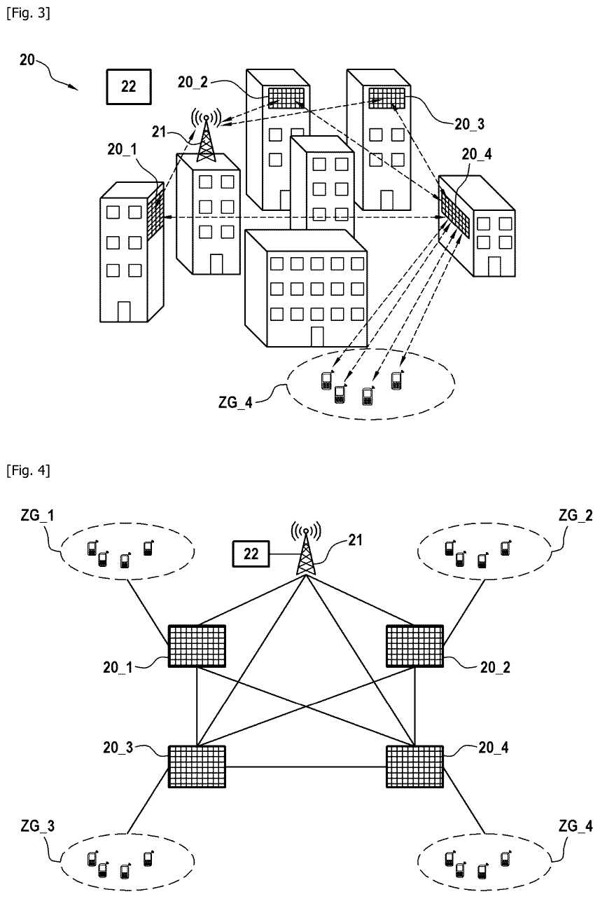

FIG. 3 schematically represents a wireless communication system 20 according to a particular embodiment of the disclosed technology.

The system 20 is based on a similar configuration to that described above with reference to FIG. 2. Consequently, the elements mentioned in relation to FIG. 2 are repeated here with identical reference numbers. It is however important to note that from now on the configuration of FIG. 3 is distinguished from that of FIG. 2, at least in that the roles respectively played by the deployed RISs (i.e. a role of intermediate RIS or else a role of main RIS) are able to be modified according to features specific to the disclosed technology. Put still otherwise, and as will be described in more detail further on, the configuration of FIG. 3 makes it possible to dynamically determine, according to a communication context (areas to be served, presences of terminals in these areas, quality of service to be achieved for the terminals served etc.), the roles played by the RISs deployed, where, contrariwise, the prior art (see FIG. 2) is limited to a fixed configuration in terms of roles played for said RISs.

As illustrated by FIG. 3, the system 20 includes a base station 21 here serving at least one communication cell (not illustrated on the figures), as well as a plurality of RISs 20_1, 20_2, 20_3, 20_4. The plurality of RIS 20_i (i being an integer index between 1 and 4) belonging to the system 20 form a set of RIS hereinafter written “set E”.

The base station 21 includes an array of antennas (not shown on the figures) including an integer number M>1 of antennas. The antenna array is for example a uniform linear array (or ULA) in which the M antennas are arranged with a constant separation along one dimension, or else a uniform rectangular planar array (or URPA) in which the M antennas are coplanar and arranged along two dimensions with constant respective separations, etc.

Each RIS 20_i of the set E is associated with a given geographical area ZG_i of the cell it is intended to serve if it is selected, from among the RISs of the set E, as main RIS (i.e. if its role is determined as being that of main RIS.)

Only the geographical area ZG_4 is illustrated in FIG. 3 for the sake of clarity. The set of said geographical areas ZG_i is however illustrated schematically and by way of example solely in FIG. 4 which constitutes an alternative representation of FIG. 3.

As illustrated by FIG. 4, said geographical areas ZG_i respectively associated with the RIS 20_i of the set E are distinct from one another. Moreover, the RISs 20_i of the set E are connected to one another in FIG. 4 by lines symbolizing indirect (indistinct) paths between the base station 21 and the different geographical areas ZG_i according to whether such or such an RIS plays a role of intermediate RIS or else of main RIS.

It should be noted that the fact of considering four RISs 20_1, 20_2, 20_3, 20_4 constitutes only one variant implementation of the disclosed technology. In general, no limitation is attached to the number of RISs which may be envisioned, such as for example more or less than four RISs. This number can moreover be greater than or less than the number of antennas equipping the base station 21.

According to similar considerations, the system 20 can also include a plurality of base stations, and each base station can serve one or more communication cells. In practice, the principles described hereinafter can be extended to the case where several base stations 21 are used to serve the geographical areas ZG_i.

Moreover, the fact of considering that the incident signals intended to be reflected by the intermediate RISs 20_j are emitted by a base station constitutes only one variant implementation of the disclosed technology. In general, the emission of said signals can be done by any access point of a design known per se.

Moreover, in the example of FIG. 4, each geographical area ZG_i is represented as being a connected area (i.e. forming a single whole). However, nothing precludes the envisioning of at least one of said areas ZG_i including a plurality of discontinuous sub-areas (i.e. each of said sub-areas forms a connected component of said area).

For the remainder of the description, it will be considered without any limitation that no role has for the time being been determined for each of said RISs 20_i, the determination of the roles being more specifically done during the implementation of a control method according to the disclosed technology described hereinafter. It should however be noted that these provisions are not limiting of the disclosed technology, and that nothing precludes the envisioning of roles having been previously determined for each of said RISs 20_i (for example as in the case of FIG. 2) according to an initial configuration, but being nonetheless intended to be modified by means of said control method.

The spatial distribution of the RISs 20_i of the set E has the aim of improving the communications performance between the base station 21 and antennas located in each of said geographical areas ZG_i to be served.

More particularly, in the embodiment described here, it is considered without any limitation that said antennas equip user terminals (or UE for User Equipment), each user terminal being equipped, in the example envisioned here, with a single antenna. A user terminal can for example take the form of a mobile telephone, such as for example a smart mobile phone (or smartphone), a digital tablet, a laptop computer, a personal assistant, a connected watch, an electronic reader, etc. In general, no limitation is attached to the form taken by a user terminal.

The disclosed technology is of course not limited to the scenario in which each user terminal is equipped with a single antenna. Thus, nothing precludes the envisioning of one or more user terminals situated in the geographical area ZG being equipped with several antennas.

The locations at which the different RISs 20_i of the set E are implemented depend on different criteria. For example, independently of the relative positions of the different RISs 20_i with respect to one another, said RIS 20_i may be spatially distributed within the communication cell such that the associated geographical areas ZG_i cover hard-to-access areas in terms of direct transmission of data from the base station 21.

Moreover, and as mentioned above, the rank of the matrix of the propagation channel between the base station 21 and a RIS of the set E playing a role of main RIS can be improved if the other RISs playing a role of main RIS are spatially distributed with respect to the base station 21 and/or with respect to the main RIS.

In practice, and without any limitation, a fictitious situation will be considered in which a given configuration of distribution of roles (intermediate, main) between the different RIS of the set E is such that the RIS 20_4 is a main RIS, and the other RIS 20_j (j being an integer index between 1 and 3) are intermediate RISs. Thus, preferably, said intermediate RISs 20_j may be arranged in different respective directions with respect to:
the base station 21, i.e. if the angle measured at the base station 21 between the directions of two intermediate RISs 20_j, 20_j′ (j and j′ being two distinct indices) is non-zero (for example greater than 5° or greater than 10°) for each pair of intermediate RISs 20_j, 20_j′; and/or p1 the main RIS 20_4, i.e. if the angle measured at the main RIS 20_4 between the directions of two intermediate RISs 20_j, 20_j′ is non-zero (for example greater than 5° or greater than 10°) for each pair of intermediate RISs 20_j, 20_j′.

Note that the direction of an intermediate RIS 20_j with respect to the base station 21 (or with respect to a main RIS 20_4 respectively) corresponds to the direction along which radio signals emitted by the base station 21 (or reflected by the intermediate RIS 20_j respectively) arrive at the intermediate RIS 20_j (or depart from the intermediate RIS 20_j respectively) to be reflected toward the main RIS 20_4. In other words, it is the direction of the vector connecting the base station 21 (or the intermediate RIS 20_j respectively) to the intermediate RIS 20_j (or to the main RIS 20_4 respectively) in a situation of direct line of sight (LOS). This vector can in particular be characterized angularly by means of different components (elevation, azimuth, and where applicable polarization), as will be described in detail further on.

It should however be noted that, in the event of no direct path existing between the base station 21 (or the intermediate RIS 20_j respectively) and the intermediate RIS 20_j (or the main RIS 20_4 respectively), the direction between these two entities is then defined based on the main indirect path (i.e. the most energetic) connecting them.

Preferably, in particular in the case where the exchanges of data with the user terminals use high frequencies (for example greater than 30 GHz or even greater than 1 THz):
the base station 21 is in a situation of direct line of sight (LOS) with all or part of the intermediate RISs 20_j, and/or
the main RIS 20_4 is in a situation of direct line of sight (LOS) with all or part of the geographical area ZG_4 to be served, and/or
the main RIS 20_4 is in a situation of direct line of sight (LOS) with all or part of the intermediate RISs 20_j.

In practice, to improve the rank of the matrix of the propagation channel between the base station 21 and the main RIS 20_4, it is possible to determine optimal positions of the different intermediate RISs 20_j by simulation, for example by using a 3D model of the environment in which said intermediate RISs 20_j must be installed. It is also possible to carry out rank tests by physically installing the different intermediate RISs 20_j in possible positions of the environment and to keep, from among all the tested possible positions, the positions for which the best rank was obtained.

The aspects mentioned above with reference to the respective positions of the RISs of the set E with respect to one another, but also vis-à-vis the base station 21 and the geographical areas, have been described in the context of the specific configuration in which the RIS 20_4 is a main RIS, and the other RIS 20_j (j being an integer index between 1 and 3) are intermediate RISs. It will however be understood that they are applicable in the same way to any other configuration in terms of distribution of the roles played between the different RISs 20_i of the set E.

Also, in the context of the disclosed technology, it is considered that the RISs 20_i of the set E are fixed, their respective positions resulting from such a procedure consisting in seeking appropriate sites to satisfy all or part of the aforementioned criteria (transmission to one or more hard-to-access areas, improvement of the rank) for one or more configurations of distribution of the roles, it being understood that this distribution of the roles is intended to be modified over time.

In a manner known per se, each RIS 20_i includes a command module (not shown on the figures) and reflective elements (not shown on the figures) the reflection properties of which are modifiable by the command module such as to influence the way in which radio signals incident on said reflective elements are reflected by these.

The reflective elements of an RIS 20_i can be of any type known to those skilled in the art. Different RISs of the system 20 may in particular use different types of elements, or else the same type of elements.

Note that the number of elements per RIS 20_i may vary from one RIS to another. However, nothing precludes, according to certain examples, having the same number of elements for all the RISs 20_i of the set E.

The command module includes, for example, at least one processor and at least one memory (magnetic hard disk, electronic memory, optical disk, or any type of recording medium readable by a computer) in which a computer program product is stored, in the form of a set of program code instructions to be executed to modify the reflective properties of the reflective elements of an RIS 20_i. Alternatively or additionally, the command module can include one or more programmable logic circuits (FPGA, PLD, etc.), and/or one or more application-specific integrated circuits (ASIC, etc.), and/or an assembly of discrete electronic components etc., suitable for carrying out all or part of the modifications of the reflective properties of the elements of an RIS 20_i.

Note that the term “modifications of the reflective properties of the reflective elements of an RIS 20_i” refers in this disclosure to the fact of modifying the phase shifts respectively introduced by the reflective elements of said RIS 20_i.

Note also that the phase shifts (i.e. phase shift values) used by the command module of a RIS 20_i to modify said reflective properties are not determined, in the embodiment described here, by the command module itself, but by a device external to the RISs of the set E, the so-called “control device 22”, belonging to the wireless communication system 20.

More specifically, the control device 22 is configured to configured to carry out processing making it possible to determine phase shifts (i.e. phase shift values) intended to be used by the respective command modules of the RISs 20_i, by implementing a control method according to the disclosed technology.

In this embodiment, the control device 22 is external to the RIS 20_i of the set E and also to the base station 21. However, nothing precludes the envisioning of the control device 22 being incorporated into the base station 21, into one of the RIS of the set E (such that this RIS can determine phase shifts independently) or distributed over several RIS of the set E.

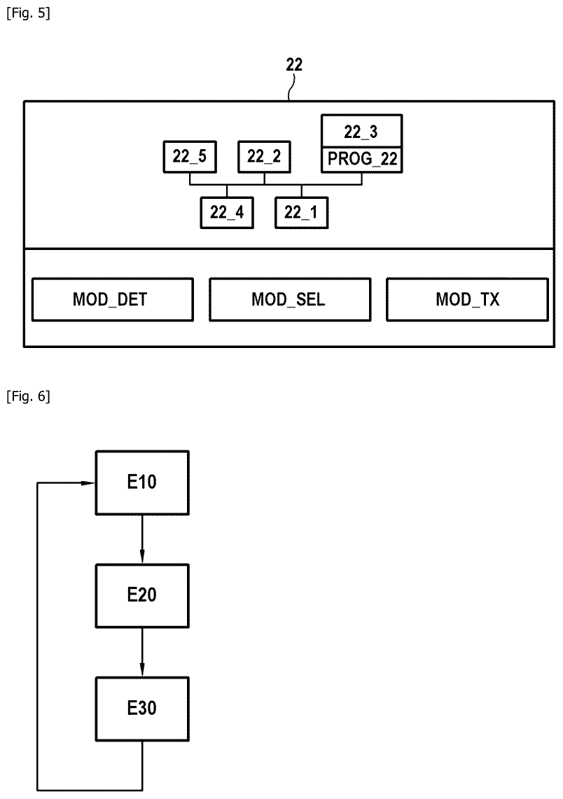

FIG. 5 schematically represents an example of a hardware architecture of the control device 22 belonging to the system 20 of FIGS. 3 and 4.

As illustrated by FIG. 5, the control device 22 has the hardware architecture of a computer. Thus, the control device 22 includes, in particular, a processor 22_1, a random access memory 22_2, a read-only memory 22_3 and a non-volatile memory 22_4. It also possesses communication means 22_5.

The read-only memory 22_3 of the control device 22 constitutes a recording medium in accordance with the disclosed technology, readable by the processor 22_1 and on which is recorded a computer program PROG_22 in accordance with the disclosed technology, including instructions for executing steps of the control method. The program PROG_22 defines functional modules of the control device 22, which are based on or command the hardware elements 22_1 to 22_5 of the control device 24 mentioned previously. These functional modules are illustrated on FIG. 5 without any limitation, and are described in more detail below with reference to different embodiments.

The communication means 22_5 in particular allow the control device 22 to exchange data with any equipment item of the wireless communication system 20, including in particular the RISs 20_i of the set E via a backhaul network. For this purpose, the communication means 22_5 include a communication interface, wired or wireless, able to implement any suitable protocol known to those skilled in the art.

In its general principle, the control method according to the disclosed technology has the aim of assigning, for each of the RISs of the set E, a role to be played as intermediate RIS or main RIS, it being understood that the determining of a role of intermediate RIS for a given RIS 20_i of the set E defines an association of this RIS 20_i with a main RIS toward which it is intended to reflect signals initially emitted by the base station 21. In the remainder of the text, the control method according to the disclosed technology makes provision for each of the RISs of the set E to then be configured effectively to play the role that has been assigned to it.

It should be noted that, as mentioned above, the control method is here implemented based on a situation in which no role has for the time being been assigned to the RISs 20_i of the set E. It is therefore a question of making a first assignment of roles to these RISs 20_i, it being understood that these roles may then be modified according to provisions similar to those implemented during said first assignment, as detailed hereinafter. Whatever the circumstances, the description that follows can of course be adapted to the situation in which the control method is implemented even though roles have already been assigned, for example following a previous implementation of the control method or else due to other technical considerations (e.g. random determination of roles during an initialization phase).

FIG. 6 represents, in the form of a block diagram, the main steps of the control method executed by the control device 22 according to a particular embodiment.

In this embodiment, the control method includes a step E10 of selecting, from among the set E, at least one intermediate RIS and at least one main RIS. Said step E10 is implemented by a selecting module MOD_DET equipping the control device 22.

More specifically, the selection forming the subject of step E10 is made so as to optimize a determined communication performance criterion KPI for user terminals situated in the geographical area ZG_i served by each RIS 20_i selected as main surface.

No limitation is attached to the nature of the criterion KPI, and the choice of a particular type of criterion KPI corresponds to only one possible variant of the disclosed technology.

For example, the criterion KPI is representative of at least one element from among:
a bitrate of the data which can be exchanged between the base station 21 and the user terminals situated in the geographical area ZG_i served by each main RIS. In this scenario, the optimization of the criterion KPI for example has the aim of maximizing said bitrate;
a level of quality of service of the exchanges of data between the base station 21 and the user terminals situated in the geographical area ZG_i served by each main RIS. In this scenario, the optimization of the criterion KPI for example has the aim of maximizing said level of quality of service (for example by minimizing the latency of the exchanges);
an energy required to make exchanges of data between the base station 21 and the user terminals situated in the geographical ZG_i area served by each main RIS. In this scenario, the optimization of the criterion KPI for example has the aim of minimizing the energy required to make said exchanges of data;
a signal-to-noise ratio of the exchanges of data between the base station 21 and the user terminals situated in the geographical area ZG_i served by each main RIS. In this scenario, the optimization of the criterion KPI for example has the aim of having a signal-to-noise ratio greater than a determined threshold or maximized.

In this embodiment, the control method also includes a step E20 of determining phase shifts of reflective elements of the RISs 20_i of the set E according to whether they have been selected as intermediate or main surfaces following the execution of step E10. Said step E20 is implemented by a determining module MOD_DET equipping the control device 22.

As mentioned above, and for each of the RISs of the set E, the role of which has been determined as being that of an intermediate RIS, the phase shifts are determined such that signals emitted by the base station 21 to exchange data with the user terminals situated in the geographical area or areas ZG_i respectively associated with the RIS or RISs of the set E playing a role of main RIS are reflected by the RIS or RISs of the set E playing a role of intermediate RIS. Of course, the determining of phase shifts of the step E20 also includes, for each of the RISs of the set E, the role of which has been determined as being that of a main RIS, a determining of phase shifts to serve the geographical area ZG_i which is associated with it.

Subsequently, once the phase shifts have been determined for each of the RISs 20_i of the set E, said phase shifts are transmitted toward each of said RISs 20_i during a control step E30. Said step E30 is implemented by a transmission module MOD_TX equipping the control device 22 and incorporated into the communication means 22_5.

It should be noted that the transmission of said phase shifts toward each of said intermediate RISs 20_j (i.e. toward each of the command modules equipping said intermediate RISs 20_j) constitutes as such a control of these latters in this embodiment since, on receiving said phase shifts, each reflective element applies the phase shift that corresponds to it, as already mentioned above. It should however be noted that the term “controlling” in “controlling step E30” can take on another meaning in other embodiments according to which the command device of an intermediate RIS 20_j is itself in charge of determining said phase shifts (i.e. in this case, the “controlling” no longer includes the transmission of the phase shifts and is done in its entirety at said intermediate RIS 20_j).

It should be noted that the control method has been described up until now by considering that the phase shifts are first determined for all the intermediate RISs 20_j of the set E, then transmitted to each of these latters. Of course, nothing precludes the envisioning of the phase shifts intended for a given RIS being transmitted to it as soon as they have been determined (i.e. without waiting for the phase shifts of the other RISs to have also been determined).

Moreover, while the step E10 is described as being implemented before the step E20, nothing precludes the envisioning of this latter being implemented during the execution of the step E10. Specifically, the optimization of the criterion KPI can for example consist in testing all the possible configurations in terms of roles assigned to the different RIS 20_i of the set E, and, for a given configuration, evaluating the criterion KPI based on quantities computed during the execution of step E20.

Advantageously, and as illustrated by FIG. 6, the steps E10, E20, E30 together form a set of steps which can be iterated. Proceeding in this way makes it possible to modify the distribution of the roles played by the RIS_i of the set E, which offers the possibility of taking into account the dynamic evolution of the user terminals within the geographical areas respectively associated with said RIS 20_i of the set E and thus serving these latters effectively.

For example, said set of steps is iterated according to a determined time increment corresponding to the coherence time associated with the signals emitted by the base station 21.

According to another example, said set of steps is iterated according to a determined time increment corresponding to a determined slot of said coherence time.

The optimization problem to be solved during the execution of the step E10 can be expressed in different ways, according to the criterion KPI taken into consideration, but also optionally according to the taking into account of restrictions which may concern the criterion KPI chosen (maximization/minimization of a physical quantity etc.) but also other aspects such as for example:
a distribution of user terminals between all or part of the geographical areas ZG_i respectively associated with the RIS 20_i of the set E, and/or
a priority of service of all or part of the geographical areas ZG_i respectively associated with the RIS 20_i of the set E, and/or
a minimal equity of service between all or part of the geographical areas ZG_i respectively associated with the RIS 20_i of the set E (for example, one ensures that, over a determined time period, each area has been served a given number of times).

Whatever the circumstances, and in general, any method of optimization of the criterion KPI may be envisioned, the choice of a particular method corresponding to only one variant implementation of the disclosed technology.

A description will now follow of different exemplary implementations of the step E10 of determining the roles played by said RISs 20_i of the set E. More specifically, different formulations of the criterion KPI optimization problem which may be envisioned during the execution of the selecting step E10 will be described.

According to a first example, the following optimization problem can be solved:

$${max}_{{x}_{1} … {x}_{I}} {\sum }_{i = 1}^{I} {\sum }_{m = 1}^{{M}_{i}} {x}_{i} {KPI}_{i , m}$$

where:
KPI_{i,m} is the performance criterion KPI related to a user terminal U_m served by the RIS 20_i,
Σᵢ₌₁^{I}xᵢ≤1, with xᵢ∈{0,1}∀i, and I corresponds to the number of RISs 20_i belonging to the system 20 (I=4 in the context of this description),
xᵢ equal to 1 (or equal to 0 respectively) indicates that the RIS 20_i is selected as main RIS (or an intermediate RIS respectively),
Mᵢ corresponds to the number of user terminals situated in the geographical area ZG_i served by the RIS 20_i when it is selected as main RIS.

Note that in this first example, Mᵢ user terminals are considered as served by the RIS 20_i at the time of solving of the criterion KPI optimization problem. More specifically, these user terminals correspond, in this first example, to predetermined terminals that said RIS 20_i is intended to serve if its role is determined as being that of main RIS. The Mᵢ user terminals concerned can be determined using any method known to those skilled in the art (channel estimate, determination and use of an item of information of CSI type, etc.). In addition, the determination of said Mᵢ terminals can be the subject of a determining step incorporated into the control method and executed prior to the selecting step E10.

Whatever the circumstances, the fact that the user terminals taken into account during the solving of the criterion KPI optimization problem are predetermined for each RIS 20_i of the set E does not constitute a limitation of the disclosed technology. For this purpose, and according to a second example, the optimization of the criterion KPI optimization problem can take into account, as optimization variable and for at least one user terminal situated in the geographical area served by a main RIS, a parameter representative of the fact that said at least one user terminal is served or not. The associated optimization problem is for example formulated as follows:

$${max}_{{x}_{i} , {y}_{m}^{i} ∀ i , m} {\sum }_{i = 1}^{I} {x}_{i} {\sum }_{m = 1}^{M} {y}_{m}^{i} {KPI}_{i , m}$$

where:
KPI_{i,m} is the performance criterion KPI related to a user terminal U_m served by the RIS 20_i,
Σᵢ₌₁^{I}xᵢ≤1, with xᵢ∈{0,1}∀i,
xᵢ equal to 1 (or equal to 0 respectively) indicates that the RIS 20_i is selected as main RIS (or as an intermediate RIS respectively),
Σₘ₌₁^{M}yₘⁱ≤Mᵢ_{ₘₐₓ}, ∀i and yₘⁱ∈{0,1}∀i, m,
yₘⁱ equal to 1 (or equal to 0 respectively) indicates that a user terminal U_m is served (or is not served respectively) by the RIS 20_i, and where Mᵢ_{ₘₐₓ} corresponds to a given maximum number of user terminals which can be served by the RIS 20_i,
M=Σᵢ₌₁^{I}Mᵢ, where Mᵢ corresponds to the number of user terminals situated in the geographical area ZG_i served by the RIS 20_i when it is selected as main RIS.

The optimization problem as formulated in this second exemplary implementation makes it possible to take more account of the fact that the user terminals may have a dynamic of their own within the communication cell served by the base station 21. The term “dynamic” of the user terminals here refers to the fact that these latters may be mobile within a geographical area, and can therefore leave it or enter it over time. It is therefore a refinement by comparison with the previous example, since the list of user terminals served is not fixed and can be adapted at the time of solving of the optimization problem.

The formulations of the criterion KPI optimization problem described until now in the first and second examples are based on the fact that a single RIS from among the RISs 20_j of the set E can play the role of main RIS. The disclosed technology is however not limited by these aspects, and nothing precludes the envisioning of the optimization of the performance criterion KPI being parameterized such that the selection of a plurality of main RISs is allowed from among the RISs 20_i of the set E. For this purpose, and according to a third example, the following optimization problem can be solved:

$${max}_{{x}_{ij} , {y}_{m}^{i} ∀ i , j , m} {\sum }_{i = 1}^{I} {x}_{i} {\sum }_{m = 1}^{M} {y}_{m}^{i} {KPI}_{i , m} ( {x}_{ij} , {y}_{m}^{i} )$$

where:
Σⱼ₌₁^{I}xᵢⱼ≤1, with xᵢⱼ∈{0,1}∀i, j,
xᵢⱼ(i≠j) equal to 1 indicates that the RIS 20_i plays the role of an intermediate RIS vis-à-vis the RIS 20_j which plays the role of main RIS,
xᵢᵢ equal to 1 (or equal to 0 respectively) indicates that the RIS 20_i plays the role of a main RIS (or of an intermediate RIS respectively),
xᵢⱼ+xⱼᵢ≤1, ∀i, j, i≠j and xⱼᵢ≤xᵢᵢ, ∀i, j, i≠j,
KPI_{i,m} is the performance criterion KPI related to a user terminal U_m served by the RIS 20_i when the encoded distribution between main RISs and intermediate RISs parameterized by xᵢⱼ is considered,
Σₘ₌₁^{M}yₘⁱ≤Mᵢ_{ₘₐₓ}, ∀i and yₘⁱ∈{0,1}∀i, m,
yₘⁱ equal to 1 (or equal to 0 respectively) indicates that a user terminal U_m is served (or is not served respectively) by the RIS 20_i, and where Mᵢ_{ₘₐₓ} corresponds to a given maximum number of user terminals which can be served by the RIS 20_i,
M=Σᵢ₌₁^{I}Mᵢ, where Mᵢ corresponds to the number of user terminals situated in the geographical area ZG_i served by the RIS 20_i when it plays the role of main RIS.

Note that the different restrictions imposed on the parameters x_{i,j}, ∀i, j in the optimization problem of this third example have the effect of partitioning the intermediate RISs according to whether they reflect signals toward such and such a main RIS. Put still otherwise, the intermediate RIS or RISs determined to reflect signals toward one main RIS are separate from the intermediate RIS or RISs determined to reflect signals toward another main RIS.

In general, the disclosed technology is not limited by the number of RISs which can be determined as being main RISs. This being the case, the number of main RISs is preferably less than or equal to the number of intermediate RISs, so as to limit the number of propagation channels between main RISs and antennas to be served within the associated geographical areas (the number of propagation channels having an influence on the quantity of computations to be made in the context of the disclosed technology).

According to a fourth exemplary embodiment, in the more specific scenario where the steps E10, E20 and E30 are iterated according to a time increment corresponding to the coherence time, the optimization of the performance criterion may take into account, as optimization variable and for each RIS 20_i of the set E, a parameter representative of the number of slots of coherence time during which said RIS 20_i plays a role of main RIS. The corresponding optimization problem can for example be formulated as follows:

$${max}_{{x}_{i} , {y}_{m}^{i} ∀ i , m} {\sum }_{i = 1}^{I} {x}_{i} {\sum }_{m = 1}^{M} {y}_{m}^{i} {KPI}_{i , m}$$

where:
KPI_{i,m} is the performance criterion KPI related to a user terminal U_m served by the RIS 20_i,
Σᵢ₌₁^{I}xᵢ=S, with xᵢ∈ [symbol] 0, S [symbol] ∀i, where S corresponds to the number of slots discretizing (dividing up) the coherence time, it being understood that these slots are here of identical sizes
xᵢ strictly greater than 1 (or equal to 0 respectively) indicates that the RIS 20_i plays the role of a main RIS during xᵢ slots of coherence time (or plays the role of an intermediate RIS respectively),
Σₘ₌₁^{M}yₘⁱ≤Mᵢ_{ₘₐₓ}, ∀i and yₘⁱ∈{0,1}∀i, m,
yₘⁱ equal to 1 (or to 0 respectively) indicates that a user terminal U_m is served (or is not served respectively) by the RIS 20_i, and where Mᵢ_{ₘₐₓ} corresponds to a given maximum number of user terminals which can be served by the RIS 20_i,
M=Σᵢ₌₁^{I}Mᵢ, where Mᵢ corresponds to the number of user terminals situated in the geographical area ZG_i served by the RIS 20_i when it plays the role of main RIS.

It will be understood that the optimization problem of this fourth example provides an effective trade-off in terms of optimality/computational load ratio. Specifically, the frequency at which the optimization problem is solved (coherence time) does indeed limit the taking into account of the dynamic of the user terminals, but nonetheless makes it possible to reduce the computational load. Whatever the circumstances, this optimization problem also makes it possible to take into account, via said restriction Σᵢ₌₁^{I}xᵢ=S, of the proportion of time (over the total duration of the coherence time) during which an RIS 20_i plays the role of main RIS, which advantageously contributes to improving said optimality/computational load ratio.

Note that the first, second, third and fourth examples detailed above with reference to the formulation of the optimization problem of the step E10 have been described independently from one another. This being the case, nothing of course precludes the envisioning of the formulation of a criterion KPI optimization problem by taking into account the characteristics of all or part of said first, second, third and fourth examples and according to any technically operable combination.

It is also important to note that the disclosed technology covers modes in which the KPI criteria respectively considered during two iterations of the set of steps E10, E20, E30 are distinct.

Besides the aspects related to the determining of the roles of the RISs 20_i of the set E, it is also possible to envision more specific exemplary implementations of the step E20 of determining the phase shifts.

For the remainder of the description of the control method, it is considered for purely illustrative purposes that, following an execution of the step E10, a role of intermediate RIS has been determined for each of the RISs 20_1, 20_2 and 20_3 as well as a role of main RIS for the RIS 20_4.

In order to describe more specific exemplary embodiments of the step E20 in the context of this specific distribution of the roles between the RISs of the set E, the following notations are introduced.

The integer index j between 1 and 3 is used to denote an intermediate RIS 20_j.

N_{20_i} denotes the number of reflective elements of a RIS 20_i. It is also considered without any limitation that a reflective element of a RIS 20_i is of square shape, the length of a side of the square being hereinafter written L_{20_i}. It will however be understood that these considerations are not limiting of the disclosed technology, and that, insofar as each RIS 20_i can be likened to a two-dimensional surface, for example of rectangular shape, nothing precludes differentiating between the lengths of a reflective element of a RIS 20_i along two directions x and y representative of the main directions along which the RIS 20_i extends. Note that the axes bearing the directions x and y thus form a frame of reference attached to the RIS 20_i (the direction written z being that orthogonal to the plane formed by the directions x and y).
ψ_{21→20_j} denotes a vector, the so-called “vector of angles of incidence”, corresponding to the direction of an incident wave coming from the base station 21 and directed toward an intermediate RIS 20_j. This vector includes three components θ_{21→20_j}, ϕ_{21→20_j}, ω_{21→20_j} respectively corresponding to the elevation, azimuth and polarization associated with said direction.

ψ_{20_j→20_4} denotes a vector, the so-called “vector of angles of arrival”, corresponding to the direction of a wave reflected by an intermediate RIS 20_j toward the main RIS 20_4. This vector includes two components θ_{20_j→20_4}, ϕ_{20_j→20_4} respectively corresponding to the elevation and the azimuth associated with said direction.

A_{21→20_j} denotes a matrix representative of the directions of waves transmitted by the base station 21 toward the N_{20_j} elements of a reflection of an intermediate RIS 20_j. Each column of the matrix A_{21→20_j} corresponds to a steering vector of an existing transmission path between the base station 21 and the intermediate RIS 20_j.

D_{20_j→20_4} denotes a matrix representative of the directions of the waves reflected by the N_{20_j} reflective elements of an intermediate RIS 20_j toward the N_{20_4} reflective elements of the main RIS 20_4. Each column of the matrix D_{20_j→20_4} corresponds to a steering vector of an existing transmission path between the intermediate RIS 20_j and the main RIS 20_4.

$${B}_{x} ( {ψ}_{21 \to 20 \_ j} ) = sin {θ}_{21 \to 20 \_ j} cos {ϕ}_{21 \to 20 \_ j}$$

$${B}_{y} ( {ψ}_{21 \to 20 \_ j} ) = sin {θ}_{21 \to 20 \_ j} sin {ϕ}_{21 \to 20 \_ j}$$

$${B}_{z} ( {ψ}_{21 \to 20 \_ j} ) = cos {θ}_{21 \to 20 \_ j}$$

$${B}_{x} ( {ψ}_{20 \_ j \to 20 \_ 4} ) = sin {θ}_{20 \_ j \to 20 \_ 4} cos {ϕ}_{20 \_ j \to 20 \_ 4}$$

$${B}_{y} ( {ψ}_{20 \_ j \to 20 \_ 4} ) = sin {θ}_{20 \_ j \to 20 \_ 4} sin {ϕ}_{20 \_ j \to 20 \_ 4}$$

$${B}_{z} ( {ψ}_{20 \_ j \to 20 \_ 4} ) = cos {θ}_{20 \_ j \to 20 \_ 4}$$

$${B}_{p} = {B}_{p} ( {ψ}_{21 \to 20 \_ j} ) + {B}_{p} ( {ψ}_{20 \_ j \to 20 \_ 4} ) , ∀ p ∈ \{ x , y , z \}$$

$${B}_{x , z} = cos {ω}_{21 \to 20 \_ j} {B}_{x} ( {ψ}_{21 \to 20 \_ j} ) + sin {ω}_{21 \to 20 \_ j} {B}_{z} ( {ψ}_{21 \to 20 \_ j} )$$

Q_{20_j} denotes a diagonal matrix representative of the phase shifts applied to each of the N_{20_j} reflective elements of an intermediate RIS 20_j, and can be expressed in the following form:

$${Q}_{20 \_ j} = diag ( \overline{{g}_{20 \_ j}} {e}^{i {φ}_{20 \_ j , 1}} , … , \overline{{g}_{20 \_ j}} {e}^{i {φ}_{20 \_ j , {N}_{20 \_ j}}} )$$

an expression in which:
i is the complex number which when squared is equal to −1,
φ_{20_j,k} corresponds to the phase shift introduced by the reflective element of index k of the intermediate RIS 20_j (k=1, . . . ,N_{20_j}),

$$\overline{{g}_{20 \_ j}} = \frac{\sqrt{4 π}}{λ} {g}_{20 \_ j} ,$$

where λ corresponds to the wavelength,

$${g}_{20 \_ j} = \frac{i \sqrt{4 π} \times τ \times {L}_{20 \_ j}^{2}}{λ} sinc ( \frac{π {L}_{20 \_ j} {B}_{x}}{λ} ) sinc ( \frac{π {L}_{20 \_ j} {B}_{z}}{λ} ) ,$$

where sinc corresponds to the sine cardinal function, and τ corresponds to a coefficient of reflection of each reflective element of the intermediate RIS 20_j (this coefficient τ is between 0 and 1, and is assumed to be constant for all the reflective elements in this embodiment). As can be seen from this formula, the parameter g_{20_j} is in particular expressed as a function of geometrical characteristics of the reflective elements of the intermediate RIS 20_j, more specifically in this example as a function of the dimensional characteristic L_{20_j},
[symbol] is equal to the following quantity:

$$\frac{{B}_{y}}{\sqrt{{B}_{x z}^{2} + {B}_{y}^{2}}} {‖ \begin{matrix}cos {θ}_{20 \_ j \to 20 \_ 4} ( cos {ω}_{21 \to 20 \_ j} sin {ϕ}_{20 \_ j \to 20 \_ 4} - sin {ω}_{21 \to 20 \_ j} cos {ϕ}_{20 \_ j \to 20 \_ 4} ) \\ sin {ω}_{21 \to 20 \_ j} sin {θ}_{21 \to 20 \_ j} + cos {ω}_{21 \to 20 \_ j} cos {ϕ}_{21 \to 20 \_ j}\end{matrix} ‖}_{2}$$

where ∥·∥₂ denotes the Euclidian norm.

For the remainder of the description, it will also be considered without any limitation that the control device 22 has knowledge of the vectors ψ_{21→20_j}, ψ_{20_j→20_4}, as well as the matrices A_{21→20_j}, D_{20_j→20_4} for each of the intermediate RISs 20_j. These different data are for example stored in the non-volatile memory 22_4 of the control device 22.

These considerations are not however limiting of the disclosed technology, which can cover yet other embodiments in which all or part of said data are obtained by the control device 22 coming from another entity (in which case the control method includes a corresponding reception step), and/or all or part of said data are determined by the control device 22 (in which case the control method includes a corresponding determining step).

According to a more specific exemplary implementation, the phase shifts are determined during the step E20 such that, for each intermediate RIS 20_j, the power of the signals reflected by said intermediate RIS 20_j toward the main RIS 20_4 is greater than a given threshold or maximized.

To do this, the power of the signals reflected by said intermediate RIS 20_j toward the main RIS 20_4 is considered as being a function parameterized by:
said phase shifts (these latters therefore playing the role of optimization variables in the context of said step E20),
the angles of incidence of the signals emitted by the base station 21 toward said intermediate RIS 20_j,
the angles of departure of the signals reflected by said intermediate RIS 203_j toward the main RIS 20_4.

The fact of determining the phase shifts of the intermediate RISs 20_j in this way makes it possible to take into account the precise physical reality in which said intermediate RIS 20_j is located. This physical reality here refers to the angles of incidence and departure with which signals arrive at/are reflected by the intermediate RIS 20_j. Proceeding in this way makes it possible to configure the intermediate RIS 20_j advantageously so that the reflection of signals toward the main RIS 20_4 is carried out in a much more directed and concentrated way than in the prior art.

Considering the notations introduced previously, the response (i.e. the behavior in terms of phase and amplitude modulation) of the intermediate RIS 20_j vis-à-vis incident signals coming from the base station 21 and reflected toward the main RIS 20_4 can for example be modelled in the form of a matrix G_{20_j→20_4} of which the term situated at row I1 and at column I2 can be expressed in the following form:

$${[ {G}_{20 \_j \to 20 \_ 4} ]}_{{l}_{1} , {l}_{2}} = {d}_{20 \_ j \to 20 \_ 4}^{H} ( {ψ}_{20 \_ j \to 20 \_ 4}^{{l}_{1}} ) \times {Q}_{20 \_ j} ( {ψ}_{21 \to 20 \_ j}^{{l}_{2}} , {ψ}_{20 \_ j \to 20 \_ 4}^{{l}_{1}} ) \times {a}_{21 \to 20 \_ j} ( {ψ}_{21 \to 20 \_ j}^{{l}_{2}} )$$

an expression in which:
H denotes the conjugate transpose operator,
ψ_{21→20_j}^{l}^{₂} is the I2-th column of the vector ψ_{21→20_j},
ψ_{20_j→20_4}^{l}^{₁} is the I1-th column of the vector ψ_{20_j→20_4},
d_{20_j→20_4}^{H}(ψ_{20_j→20_4}^{l}^{₁}) is the I1-th column of the matrix D_{20_j→20_4},
a_{21→20_j}(ψ_{21→20_j}^{l}^{₂}) is the I2-th column of the matrix A_{21→20_j}

Ultimately, the power of the signals reflected by said intermediate RIS 20_j toward the main RIS 20_4 is a function of the squared modulus of said terms [G_{20_j→20_4}]ₗ_{₁}_{,l}_{₂}. Consequently, the determination of the respective phase shifts of the reflective elements of said intermediate RIS 20_j can be done by solving an optimization problem.

For example, in the scenario where one is seeking for the phase shifts to be determined such that the power of the signals reflected by said intermediate RIS 20_j toward the main RIS 20_4 is maximized, said optimization problem to be solved, hereinafter written “PB1”, is as follows:

$${max}_{γ , {φ}_{20 \_ j , 1} {…φ}_{20 \_ j , {N}_{20 \_ j}}} γ$$

where |[G_{20_j→20_4}]ₗ_{₁}_{,l}_{₂}|²>γ, ∀l₁,l₂ and φ_{20_j,k}∈[0,2π], ∀k.

Note that the parameter γ here corresponds to an intermediate parameter representative of the lower bound of the quantity |[G_{20_j→20_4}]ₗ_{₁}_{,l}_{₂}|², ∀l₁,l₂. Here the optimization problem PB1 thus has the more specific aim of maximizing this lower bound.

Any optimization method known to those skilled in the art to solve such a problem PB1 may be envisioned, the choice of a particular method being only one variant implementation of the disclosed technology.

According to another example, in the scenario where one is seeking for the phase shifts to be determined such that the power of the signals reflected by said intermediate RIS 20_j toward the main RIS 20_4 is greater than a given threshold γ, said optimization problem to be solved, hereinafter written “PB1_BIS”, consists in finding the phase shifts φ_{20_j,1} . . . φ_{20_j,N}_{_{20_j}} such that |[G_{20_j→20_4}]ₗ_{₁}_{,l}_{₂}|²>γ, ∀l₁,l₂ and φ_{20_j,k}∈[0,2π], ∀k.

Moreover, it will be understood that if each intermediate RIS 20_j is configured to reflect signals coming from the base station 21 toward the main RIS 20_4, there may be a risk of some of these reflections being uncontrolled so as to be ultimately directed elsewhere, such as for example toward another intermediate RIS 20_j′ or else directly toward a user terminal. For this purpose, and advantageously, it is possible to envision other more specific examples of step E20 in which the interference vis-à-vis the other intermediate RISs and/or vis-à-vis user terminals are reduced.

For example, the phase shifts associated with an intermediate RIS 20_j can also be determined (i.e. in addition to seeking a maximization of the power of the signals reflected by said intermediate RIS 20_j toward the main RIS 20_4) such that the power of signals reflected by said intermediate RIS 20_j toward at least one other intermediate RIS 20_j′ is minimized (the contribution of the intermediate RIS 20_j toward said at least one other intermediate RIS 20_j′ is symbolized by the parameter β₁ in the remainder of the text). Once again using the notations introduced previously, the corresponding optimization problem, hereinafter written “PB2”, can then be formulated as follows:

$${max}_{γ , {β}_{1} , {φ}_{20 \_ j , 1} … {φ}_{20 \_ j , {N}_{20 \_ j}}} γ - {β}_{1}$$

where:
   |[G_{20_j→20_4}]ₗ_{₁}_{,l}_{₂}|²>γ, ∀l₁,l₂
φ_{20_j,k}∈[0,2π], ∀k,
   |[G_{20_j→20_j′}]ₗ_{₃}_{,l}_{₂}|²<β₁, ∀l₂,l₃

In this optimization problem PB2, the matrix G_{20_j→20_j}, models the response (i.e. the behavior in terms of phase and amplitude modulation) of the intermediate RIS 20_j vis-à-vis the incident signals coming from the base station 21 and reflected toward another intermediate RIS 20_j′. The determination of the terms of this matrix G_{20_j→20_j}, can be done according to similar formulae to those given above for the matrix 0_4. It will of course be understood that the power restriction concerning the matrix G_{20_j→20_j}, in the optimization problem PB2 above, can be replicated for any index j′ different from the index j.

According to another example, in the scenario where one is seeking for the phase shifts to be determined such that the power of signals reflected by the intermediate RIS 20_j toward at least one other intermediate RIS 20_j′ is less than a given threshold β₁, said optimization problem to be solved, hereinafter written “PB2_BIS”, consists in finding the phase shifts φ_{20_j,1} . . . φ_{20_j,N}_{_{20_j}} such that |[G_{20_j→20_4}]ₗ_{₁}_{,l}_{₂}|²>γ, ∀l₁,l₂, and φ_{20_j,k}∈[0,2π], ∀k and |[G_{20_j→20_j′}]ₗ_{₃}_{,l}_{₂}|²<β₁, ∀l₂,l₃.

Alternatively, the phase shifts associated with an intermediate RIS 20_j may also be determined such that the power of signals reflected by said intermediate RIS 20_j directly toward at least one user terminal situated in the geographical area ZG_4 is minimized (the contribution of the intermediate RIS 20_j toward a user terminal situated in the geographical area ZG_4 is symbolized by the parameter β₂ in the remainder of the text). Once again using the notations introduced previously, and also writing U_m an m-th user of the geographical area ZG_4, the corresponding optimization problem, hereinafter written “PB3”, can be formulated as follows:

$${max}_{γ , {β}_{2} , {φ}_{20 \_ j , 1} … {φ}_{20 \_ j , {N}_{20 \_ j}}} γ - {β}_{2}$$

where:
   |[G_{20_j→20_4}]ₗ_{₁}_{,l}_{₂}|²>γ, ∀l₁,l₂
φ_{20_j,k}∈[0,2π], ∀k,
   |[G_{20_j→U_m}]ₗ_{₄}_{,l}_{₂}|²<β₂, ∀l₂,l₄.

In this optimization problem PB3, the matrix G_{20_j→U_m} models the response (i.e. the behavior in terms of phase and amplitude modulation) of the intermediate RIS 20_j vis-à-vis the incident signals coming from the base station 21 and directly reflected toward a user U_m. The determination of the terms of this matrix G_{20_j→U_m} can be done according to similar formulae to those given above for the matrix G_{20_j→20_4}. It will of course be understood that the power restriction concerning the matrix G_{20_j→U_m} in the optimization problem PB3 above can be replicated for any index m relating to the users present in the geographical area ZG_4.

According to yet another example, in the scenario where one is seeking for the phase shifts to be determined such that the power of signals reflected by said intermediate RIS 20_j directly toward at least one user terminal situated in the geographical area ZG_4 is less than a given threshold β₂, said optimization problem to be solved, hereinafter written “PB3_BIS”, consists in finding the phase shifts φ_{20_j,1} . . . φ_{20_j,N}_{_{20_j}} such that |[G_{20_j→20_4}]ₗ_{₁}_{,l}_{₂}|²>γ, ∀l₁,l₂, φ_{20_j,k}∈[0,2π], ∀k and |[G_{20_j→U_m}]ₗ_{₄}_{,l}_{₂}|²<β₂, ∀l₂,l₄.

It is also important to note that, according to yet other exemplary implementations of the control method, the phase shifts of the reflective elements of an intermediate RIS 20_j may be determined by combining all of the optimization problems described previously. Put still otherwise, all the restrictions mentioned previously (power reflected toward the main RIS 20_4 greater than a threshold or maximized, power reflected toward a user U_m less than a threshold or minimized, power reflected toward another intermediate RIS 23_j′ less than a threshold or minimized) may be taken into account according to any technically operable combination.

The different aspects of the disclosed technology (controlling the reflective elements of the intermediate RISs 20_j, selecting the roles of the RISs 20_i of the set E) have been described until now by considering a communication downlink between the base station 21 and the user terminals distributed in the different geographical areas ZG_i. However, these arrangements are not limiting of the disclosed technology, and the different aspects of the disclosed technology can also be implemented in the context of a communication uplink between the user terminals and the base station 21.

In this context of a communication uplink between the user terminals and the base station 21, it will then be understood that a main RIS no longer represents a “focusing” surface vis-à-vis the intermediate RISs with which it is associated, but rather a “transmission” (or “broadcasting”) surface, in the sense that said intermediate RISs are intended to receive signals coming from such a transmission main RIS to reflect them toward the base station 21.

Below is a description of the updating of the formulations of the optimization problems PB1, PB2 and PB3 for the context of a communication uplink between the user terminals and the base station 21. Note that each of these optimization problems PB1, PB2 and PB3 allows, in this context of a communication uplink, two formulations according to whether one is considering a technique of transmission of signals by TDD (Time Division Duplex) or FDD (Frequency Division Duplex) multiplexing.

Thus, as regards the optimization problem PB1, it is formulated as follows in the scenario of an uplink TDD transmission (i.e. one is considering one and the same transmission frequency, and thus a fortiori one and the same wavelength λ):

$${max}_{γ , {φ}_{20 \_ j , 1} {…φ}_{20 \_ j , {N}_{20 \_ j}}} γ$$

where |[G_{20_j→21}]ₗ_{₂}_{,l}_{₁}|²>γ, ∀l₁,l₂ and φ_{20_j,k}Å[0,2π], ∀k.

As regards the optimization problem PB1, is formulated as follows in the scenario of an uplink FDD transmission (i.e. one is here considering two distinct transmission frequencies, and thus a fortiori two distinct wavelengths λ1, λ2):

$${max}_{γ , {φ}_{20 \_ j , 1} {…φ}_{20 \_ j , {N}_{20 \_ j}}} γ$$

where |[G_{20_j→21}]ₗ_{₂}_{,l}_{₁}_{λ1}|²>γ, ∀l₁,l₂ and φ_{20_j,k}Å[0,2π], ∀k,
|[G_{20_j→20_4}]ₗ_{₁}_{,l}_{₂}_{,λ2}|²>γ, ∀l₁,l₂ and φ_{20_j,k}Å[0,2π], ∀k.

As regards the optimization problem PB2, it is formulated as follows in the scenario of an uplink TDD transmission (i.e. one is considering one and the same transmission frequency, and thus a fortiori one and the same wavelength λ):

$${max}_{γ , {β}_{1} , {φ}_{20 \_ j , 1} {…φ}_{20 \_ j , {N}_{20 \_ j}}} γ - {β}_{1}$$

where |[G_{20_j→21}]ₗ_{₂}_{,l}_{₁}|²>γ, ∀l₁,l₂ and φ_{20_j,k}Å[0,2π], ∀k
|[G_{20_j′→20_j}]ₗ_{₂}_{,l}_{₃}|²<β₁, ∀l₂,l₃.

As regards the optimization problem PB2, it is formulated as follows in the scenario of an uplink FDD transmission (i.e. here one is considering two distinct transmission frequencies, and thus a fortiori two distinct wavelengths λ1, λ2):

$${max}_{γ , {β}_{1} , {φ}_{20 \_ j , 1} {…φ}_{20 \_ j , {N}_{20 \_ j}}} γ - {β}_{1}$$

where |[G_{20_j→20_4}]ₗ_{₁}_{,l}_{₂}_{,λ1}|²>γ, ∀l₁,l₂ and φ_{20_j,k}Å[0,2π], ∀k
|[G_{20_j→20_j′}]ₗ_{₃}_{,l}_{₂}_{,λ1}|²<β₁, ∀l₂,l₃
|[G_{20_j→21}]ₗ_{₂}_{,l}_{₁}|²>γ, ∀l₁,l₂
|[G_{20_j→20_j′}]ₗ_{₂}_{,l}_{₃}_{,λ2}|²<β₁, ∀l₂,l₃

As regards the optimization problem PB3, it is formulated as follows in the scenario of an uplink TDD transmission (i.e. one is considering one and the same transmission frequency, and thus a fortiori one and the same wavelength λ):

$${max}_{γ , {β}_{2} , {φ}_{2 {0}_{j} , 1} {…φ}_{2 {0}_{j} , {N}_{2 {0}_{j}}}} γ - {β}_{2}$$

where |[G_{20_j→21}]ₗ_{₂}_{,l}_{₁}|²>γ, ∀l₁,l₂ and φ_{20_j,k}Å[0,2π], ∀k
|[G_{20_j→21}]ₗ_{₂}_{,l}_{₄}|²<β₂, ∀l₂,l₄. Note that this latter restriction concerns the response (i.e. the behavior in terms of phase and amplitude modulation) of the intermediate RIS 20_j when one is considering:
incident signals coming directly from user terminals intended to be served by said intermediate RIS 20_j if it is selected as main RIS,
signals departing toward the base station 21 from the intermediate RIS 20_j.

As regards the optimization problem PB3, it is formulated as follows in the scenario of an uplink FDD transmission FDD (i.e. here one is considering two distinct transmission frequencies, and thus a fortiori two distinct wavelengths):

$${max}_{γ , {β}_{2} , {φ}_{2 {0}_{j} , 1} {…φ}_{2 {0}_{j} , {N}_{2 {0}_{j}}}} γ - {β}_{2}$$

where |[G_{20_j→20_4}]ₗ_{₁}_{,l}_{₂}_{,λ1}|²>γ, ∀l₁,l₂ and φ_{20_j,k}Å[0,2π], ∀k
|[G_{20_j→U_m}]ₗ_{₄}_{,l}_{₂}_{,λ1}|²<β₂, ∀l₂,₄
|[G_{20_j→21}]ₗ_{₂}_{,l}_{₁}_{,λ2}|²>γ, ∀l₁,l₂
|[G_{20_j→21}]ₗ_{₂}_{,l}_{₄}_{,λ2}|²<β₂, ∀l₂,l₄. Note that this latter restriction concerns the response (i.e. the behavior in terms of phase and amplitude modulation) of the intermediate RIS 20_j when one is considering:
incident signals coming directly from user terminals intended to be served by said intermediate RIS 20_j if it is selected as main RIS,
signals departing toward the base station 21 from the intermediate RIS 20_j.

The optimization problems PB1_BIS, PB2_BIS and PB3_BIS can of course be reformulated, in this context of a communication uplink, according to similar considerations to those which have just been described for the optimization problems PB1, PB2, PB3.

Although the present disclosure has been described with reference to one or more examples, workers skilled in the art will recognize that changes may be made in form and detail without departing from the scope of the disclosure and/or the appended claims.

1. A method for controlling a set of reconfigurable intelligent surfaces associated with an access point, said method being implemented by an electronic device and including:
selecting, from among the set, at least one surface as an “intermediate surface” and at least one surface as a “main surface”, each surface of the set being associated with a given geographical area covered by the access point and which the surface is intended to serve if the surface is selected as main surface, each intermediate surface being positioned between the access point and a main surface and also intended to reflect toward said main surface signals emitted by the access point to exchange data with at least one user terminal situated in the geographical area served by said main surface, the selection being made so as to optimize a determined communication performance criterion for at least one user terminal in the geographical area served by each main surface,
determining phase shifts of reflective elements of said at least one selected intermediate surface and at least one selected main surface, and
controlling reflective elements of said at least one intermediate surface and at least one main surface, both selected by using the determined phase shifts.

2. The method as claimed in claim 1, wherein the selecting, determining the phase shifts and controlling form a set of steps, said set of steps being iterated.

3. The method as claimed in claim 2, wherein said set of steps is iterated according to a determined time increment corresponding to a coherence time associated with the signals emitted by the access point, or with a determined slot of the coherence time.

4. The method as claimed in claim 1, wherein the communication performance criterion is representative of at least one element from among:
a bitrate of the data which can be exchanged between the access point and at least one user terminal situated in the geographical area served by each main surface,
a level of quality of service of the exchanges of data between the access point and at least one user terminal situated in the geographical area served by each main surface,
an energy required to carry out exchanges of data between the access point and at least one user terminal situated in the geographical area served by each main surface,
a signal-to-noise ratio of the exchanges of data between the access point and at least one user terminal situated in the geographical area served by each main surface.

5. The method as claimed in claim 1, wherein the optimization of the performance criterion takes into account, as optimization variable and for at least one user terminal situated in the geographical area served by a main surface, a parameter representative of whether said at least one user terminal is served or not.

6. The method as claimed in claim 1, said method including, prior to the selecting, determining, for each surface of the set, the user terminals to be served by said surface if the surface is selected as main surface.

7. The method as claimed in claim 3, wherein said time increment corresponding to the coherence time, said coherence time being sampled into a plurality of determined slots, the optimization of the performance criterion taking into account, as optimization variable and for each surface of the set, a parameter representative of the number of slots of the coherence time during which said surface is selected as main surface.

8. The method as claimed in claim 1, wherein the optimization of the performance criterion is parameterized such that:
selection of a plurality of main surfaces is allowed, and
the intermediate surface or surfaces selected to reflect signals toward one main surface are distinct from the intermediate surface or surfaces selected to reflect signals toward another main surface.

9. The method as claimed in claim 1, wherein the determining the phase shifts is implemented such that a power of the signals reflected by an intermediate surface toward a main surface is greater than a given threshold or maximized, said power being a function parameterized by said phase shifts, angles of the signals emitted by the access point toward said intermediate surfaces as well as angles of departure of the signals reflected by said intermediate surface toward said main surface.

10. The method as claimed in claim 9, wherein the phase shifts are also determined such that the power of signals reflected by an intermediate surface directly toward at least one user terminal situated in the geographical area served by the main surface toward which signals are reflected by said intermediate surface is less than a given threshold or minimized.

11. The method as claimed in claim 9, wherein the phase shifts are also determined such that the power of signals reflected by an intermediate surface toward at least one other intermediate surface is less than a given threshold or minimized.

12. A non-transitory computer-readable recording medium on which is recorded a computer program which when executed by a processor of the electronic device, configure the electronic device to perform the method as claimed in claim 1.

13. A control device comprising:
at least one processor; and
at least one non-transitory computer readable medium comprising instructions stored thereon which when executed by the at least one processor configure the control device to control a set of reconfigurable intelligent surfaces associated with an access point by:
selecting, from among the set, at least one surface as an “intermediate surface” and at least one surface as a “main surface”, each surface of the set being associated with a given geographical area covered by the access point and which the surface is intended to serve if the surface is selected as main surface, each intermediate surface being positioned between the access point and a main surface and also intended to reflect toward said main surface signals emitted by the access point to exchange data with at least one user terminal situated in the geographical area served by said main surface, the selection being made so as to optimize a determined communication performance criterion for at least one user terminal in the geographical area served by each main surface;
determining phase shifts of reflective elements of said at least one selected intermediate surface and at least one selected main surface; and
controlling reflective elements of said at least one intermediate surface and at least one main surface, both selected by using the determined phase shifts.

14. A method for controlling a set of reconfigurable intelligent surfaces associated with an access point, said method being implemented by an electronic device and including:
selecting, from among the set, at least one surface as an “intermediate surface” and at least one surface as a “main surface”, each surface of the set being associated with a given geographical area covered by the access point and from which the surface is intended to receive signals emitted by at least one user terminal to exchange data with the access point if the surface is selected as a main surface, each intermediate surface being positioned between the access point and a main surface from which the intermediate surface is intended to receive signals to reflect them toward the access point, the selection being made so as to optimize a determined communication performance criterion for at least one user terminal situated in the geographical area served by each main surface,
determining phase shifts of reflective elements of said at least one selected intermediate surface and at least one selected main surface,
controlling the reflective elements of said at least one intermediate surface and at least one main surface, both selected by using the determined phase shifts.

15. The method as claimed in claim 14 wherein the selecting, determining the phase shifts and controlling form a set of steps, said set of steps being iterated.

16. The method as claimed in claim 15, wherein said set of steps is iterated according to a determined time increment corresponding to a coherence time associated with the signals emitted by said at least one user terminal, or with a determined slot of the coherence time.

17. The method as claimed in claim 14, wherein the optimization of the performance criterion takes into account, as optimization variable and for at least one user terminal situated in the geographical area served by a main surface, a parameter representative of whether said at least one user terminal is served or not.

18. The method as claimed in claim 14, said method including, prior to the selecting, determining, for each surface of the set, the user terminals to be served by said surface if the surface is selected as main surface.

19. The method as claimed in claim 14, wherein the determining the phase shifts is implemented such that a power of the signals reflected by an intermediate surface toward the access point is greater than a given threshold or maximized, said power being a function parameterized by said phase shifts, angles of the signals reflected by said at least one main surface toward said intermediate surface as well as angles of the signals reflected by said intermediate surface toward the access point.

20. The method as claimed in claim 19, wherein the phase shifts are also determined such that the power of signals reflected by an intermediate surface directly toward at least one user terminal situated in the geographical area served by the main surface toward which signals are reflected by said intermediate surface is less than a given threshold or minimized.
